(19) United States
(12) Patent Application Publication
(10) Pub. No.: US 2024/0124675 A1
(43) Pub. Date: Apr. 18, 2024

(54) POROUS POLYMER STRUCTURE HAVING SMOOTH SURFACE, METHOD FOR PRODUCING SAME, AND PROTECTIVE FILM COMPRISING SAME

(71) Applicant: IUCF-HYU (INDUSTRY-UNIVERSITY COOPERATION FOUNDATION HANYANG UNIVERSITY), Seoul (KR)

(72) Inventors: Dong Rip KIM, Seoul (KR); Sungwon JO, Seoul (KR); Haeyeon LEE, Guri-si (KR); Hanmin JANG, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 18/277,715

(22) PCT Filed: Feb. 16, 2022
(86) PCT No.: PCT/KR2022/002268

§ 371 Date: Aug. 17, 2023

(30) Foreign Application Priority Data
Feb. 18, 2021 (KR) 10-2021-0022139
Feb. 4, 2022 (KR) 10-2022-0015063

(51) Int. Cl. C08J 9/30; C08J 5/18; C08J 9/36

(52) U.S. Cl. CPC C08J 9/30; C08J 5/18; C08J 9/36; C08J 2201/0504; C08J 2383/04

(57) ABSTRACT

A porous polymer structure having a smooth surface and a porous structure embedded below the surface can be simply produced by using a hydrophobic substrate with a steam spraying process, and the porous polymer structure can exhibit very excellent low-adhesive property due to the smooth surface and the porous structure embedded below the surface.

It is possible to realize excellent low-adhesive property even without using a surface modifier or a lubricant. Since the structure shows flexibility, it can even be attached to a curved surface, and can be usefully applied to various industries due to a possible adjustment of the surface characteristic.

### TECHNICAL FIELD

The present invention relates to a porous polymer structure having a smooth surface, a method for producing the same, and a protective film comprising the same, and more particularly, is directed to a porous polymer structure having a smooth surface and having a porous structure embedded below its surface to exhibit a low adhesion and a stain resistance, a method for producing the same, and a protective film comprising the same.

### BACKGROUND ART

Accumulation of foreign substances such as an ice and a scale on the surface of a ship or an aircraft not only causes a hygiene problem, but also reduces a thermal fluid performance and an energy efficiency due to increased thermal resistance or frictional drag. Accordingly, research has been actively conducted to produce a low-adhesive surface that has a low adhesion to the foreign substances and facilitates removal of the attached foreign substances.

In general, a superhydrophobic surface has been used as the low-adhesive surface to prevent ice formation and contamination by other liquids. For example, the superhydrophobic surface may be formed by forming a three-dimensional micro/nano structure or using a surface modifier such as a fluorine-based solution. However, the superhydrophobic surface formed in this way has a problem in that surface characteristics deteriorate when the structure collapses by the stress concentration with an external material or the coating is peeled off.

In order to solve the above problem by securing stability against this external pressure, a technique of forming a slippery surface by injecting a lubricant into a structured surface or a planar polymer has been developed, but in this case, since loss of the lubricant occurs as time pass, there has been faced a problem that it is difficult to maintain the low-adhesive property over a long period of time.

For example, Korean Patent Registration Publication No. 10-1410826 relating to a superhydrophobic surface in which nanostructures and microstructures coexist discloses a technique that forms the superhydrophobic surface by forming the nanostructures on the surface of an aluminum metal using anodic oxidation followed by forming the microstructures with etching, and coating a superhydrophobic material. However, this technique has a problem in that the process is complicated and expensive because the nanostructures and the microstructures must be formed, respectively, and that the contact area with an ice becomes large because a lubricating layer forms a two-dimensional plane.

Further, Korean Patent Registration Publication No. 10-2167880 relating to an icephobic paint describes a paint capable of controlling elution of an oil over time. However, according to this technology, in order to control elution of the oil, it is necessary to mix a polymer capsule containing the oil with a polymer resin and to adjust refractive indexes of the polymer capsule and the oil, and so, there is a limitation that a problem of oil loss cannot be avoided in a period of long time.

Accordingly, there has been a need to develop a coating or film structure capable of realizing the low-adhesive property and the stain resistance without using a surface modifier/lubricant and having no risk of a structural damage due to the external pressure. In addition, in order to be used in various industrial fields, it is desirable to exhibit flexibility so that the structure can be attached to a curved surface. Further, if the structure can implement a surface with the low-adhesive property while exhibiting not only hydrophobicity but also hydrophilicity, it is expected that application field of the structure can be expanded more widely.

Under the circumstance, the inventors of the present invention have developed a technology capable of producing a flexible structure having a smooth top surface using a polymer and having a pore network embedded below the surface, in a very simple way. The present invention was completed by confirming that such a structure exhibits excellent low-adhesive property to an ice and a scale.

### DISCLOSURE

### Technical Problem

An object of the present invention is to provide a method for producing a porous polymer structure having a smooth surface.

Another object of the present invention is to provide a porous polymer structure having excellent low-adhesive property and stain resistance due to a smooth surface and an internal porous structure.

Still another object of the present invention is to provide a film for surface protection using a porous structure with a smooth surface.

### Technical Solution

In order to achieve the above objects, the present invention provides a method for producing a porous polymer structure with a smooth surface.

The method of the present invention comprises the steps of coating a thermosetting polymer on a hydrophobic substrate; forming a porous polymer structure by curing the coated thermosetting polymer while spraying steam to it; and separating the porous polymer structure from the hydrophobic substrate to obtain a porous polymer structure having a smooth surface.

According to the present invention, a water contact angle of the hydrophobic substrate may be 90° or more.

According to the present invention, the thermosetting polymer may include one or more selected from the group consisting of polydimethylsiloxane (PDMS), silicone rubber, polymethyl methacrylate (PMMA), polyurethane (PU), polyester, polyimide (PI), polycarbonate (PC), and epoxy resin.

According to the present invention, at least one strengthener selected from the group consisting of silica, nanocarbon, metal particles and metal oxide particles may be added to the thermosetting polymer.

According to the present invention, the step of spraying steam may be performed by spraying steam of 100 to 150° C. and 70 to 200 kPa to the coated thermosetting polymer.

The method of the present invention may further comprise the step of drying the thermosetting polymer after curing it.

According to the present invention, a thickness of the porous polymer structure may be 50 μm to 10 mm.

The method of the present invention may further comprise the step of carrying out a hydrophilic surface treatment or a hydrophobic surface treatment on the smooth surface.

The present invention also provides a porous polymer structure comprising a surface portion having a smooth surface; and a porous structure below the surface portion.

According to the present invention, an arithmetic average roughness (Ra) of the smooth surface may be 0.01 to 1 μm.

According to the present invention, the surface portion may include pores having an average particle diameter of 0.1 to 2 μm.

According to the present invention, the average particle diameter of the pores in the porous structure may be 10 to 50 μm.

According to the present invention, a distance between the surface portion and the porous structure may be 30 μm or less.

According to the present invention, the smooth surface may be subjected to a hydrophilic surface treatment or a hydrophobic surface treatment.

Further, the present invention provides a film for protecting a surface of a transportation means, comprising the porous polymer structure having the smooth surface.

### Advantageous Effects

According to the present invention, a porous polymer structure having a smooth surface can be simply produced by using a hydrophobic substrate with a steam spraying process, and the porous polymer structure of the present invention can exhibit very excellent low-adhesive property due to the smooth surface and a porous structure embedded below the surface.

It is possible to realize excellent low-adhesive property even without using a surface modifier or a lubricant, according to the present invention. Since the structure of the present invention shows flexibility, it can even be attached to a curved surface, and can be usefully applied to various industries due to a possible adjustment of the surface characteristic.

### DESCRIPTION OF THE DRAWINGS

FIG. 1 schematically shows a method for producing a smooth porous structure according to the present invention.

FIG. 2 shows a photograph (left), an optical microscope image (center), and an SEM image (right) of a smooth porous structure produced in an embodiment of the present invention.

FIGS. 3a and 3b show a photograph (left) and an optical microscope image (right) having a smooth porous structure attached to a convex surface (a) and a concave surface (b) according to an embodiment of the present invention.

FIGS. 4a and 4b show a difference in surface characteristics varying with wettability of a handling substrate in a method for producing a porous structure according to an embodiment of the present invention.

FIGS. 5a and 5b show a difference in pore size distribution varying with wettability of a handling substrate in a porous structure produced in an embodiment of the present invention.

FIG. 6 shows the results of measuring an ice adhesion strength of a structure according to an embodiment of the present invention.

FIG. 7 shows an ice adhesion-position profile of a structure according to an embodiment of the present invention.

FIG. 8 is a graph showing the results of measuring an ice adhesion strength after superhydrophilic treatment or superhydrophobic treatment of the surface of a structure according to an embodiment of the present invention.

FIG. 9 shows a photograph of a flow circulation device for testing an anti-scale performance in experimental examples of the present invention.

FIG. 10 shows photographs before and after scale accumulation of a structure according to an embodiment of the present invention.

FIG. 11 is a graph showing the results of measuring an amount of the accumulated scale after scale is accumulated to a structure according to an embodiment of the present invention.

FIG. 12 shows a comparison between photographs of a scale-formed surface and a washed surface after forming and washing the scale on a structure according to an embodiment of the present invention.

FIG. 13 shows a critical flow rate for scale removal and a removal rate at each critical flow rate for a structure according to an embodiment of the present invention.

### MODE FOR INVENTION

Hereinafter, specific aspects of the present invention will be described in more detail. Unless defined otherwise, all technical and scientific terms used in the specification have the same meaning as that commonly understood by a skilled person in the technical field to which the present invention belongs. In general, the nomenclatures used herein are well known and commonly used in the relevant art.

The present invention relates to a porous polymer structure comprising a surface portion having a smooth surface; and a porous structure below the surface portion, a method for producing the porous polymer structure, and an application of the porous polymer structure.

Since the porous polymer structure of the present invention has a smooth surface, it does not cause an interlocking phenomenon that induces increase in an adhesion because of entanglement of foreign substances on the surface. In addition, since a porous structure including a structured pore network is embedded below the surface, a stress concentration effect occurs. The structure of the present invention can exhibit low-adhesive property such that adhesion to external materials is low and materials attached to the surface are easily separated by combination of such a surface characteristic and internal structure. Further, when hydrophilic surface treatment is applied to the structure, a surface having superhydrophilicity and relatively low adhesion can be formed and ultralow-adhesive property can be realized through hydrophobic surface treatment. Furthermore, the porous polymer structure of the present invention can be formed of a flexible polymer having a thin thickness, and thus can be attached to a curved surface.

According to the present invention, the smooth surface is a concept that is distinguished from a slippery surface with very low roughness or a surface on which microstructures (structured surface) of micro/nano level are formed, and the smooth surface defined in the present invention is interpreted as a concept meaning a surface having an arithmetic average roughness (Ra) in the range of 0.01 to 1 μm and having small pores with an average particle diameter of 0.1 to 2 μm on the surface portion. In this case, the surface portion may refer to a range from a top surface to the depth at which such small pores are formed.

According to the present invention, the porous structure below the surface portion may include a pore network. The pore network is formed by interconnected pores, and the porous structure of the present invention may include a hierarchical porous structure in which a plurality of relatively small pores is connected to relatively large pores.

According to the present invention, the low-adhesive property refers to a characteristic that the adhesion to external materials is low and removal of the attached materials is easy, and, in particular, it may mean a characteristic that an adhesion to an ice and a scale is low and the attached materials can be easily removed.

According to the present invention, the porous polymer structure comprising a surface portion having a smooth surface, and a porous structure below the surface portion may be referred to as a porous polymer structure having a smooth surface or a smooth porous polymer structure for convenience of description.

The smooth porous polymer structure according to the present invention can be formed by coating a polymer on a hydrophobic substrate and curing the coated polymer while spraying steam to it.

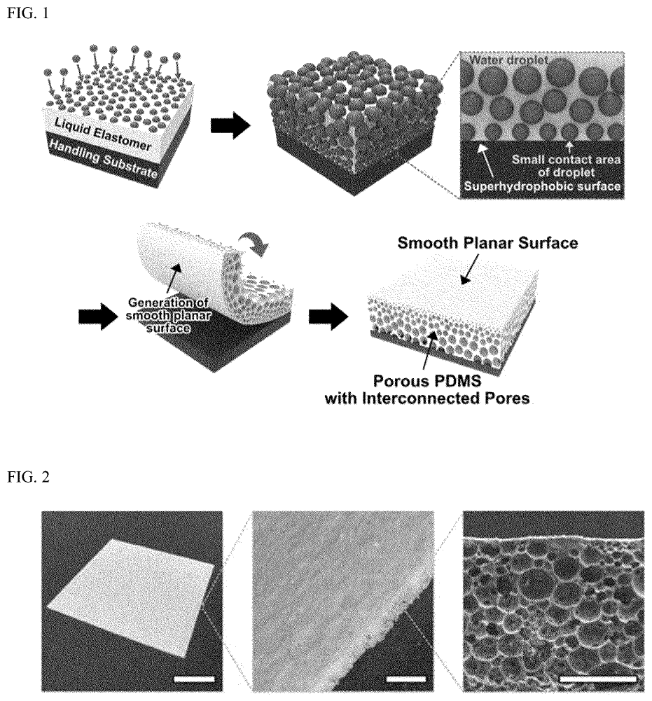

FIG. 1 schematically shows a method for producing a smooth porous polymer structure according to the present invention. The smooth porous polymer structure of the present invention can be produced by the steps of coating a thermosetting polymer on a hydrophobic substrate; forming a porous polymer structure by curing the coated thermosetting polymer while spraying steam to it; and separating the porous polymer structure from the hydrophobic substrate to obtain the porous polymer structure having a smooth surface.

The present invention is characterized in that the hydrophobic substrate is used as a handling substrate in forming a porous structure with a polymer using the steam spraying, whereby the smooth surface can be formed on a surface on which the polymer contacts the hydrophobic substrate. In addition, since the contact area and curing rate of water molecules penetrating into the polymer can be controlled by adjusting a wettability of the handling substrate and a heat flux, a size and depth of the pores can be controlled.

According to the present invention, the handling substrate is a temporary substrate which is used for forming the structure. The handling substrate may be a hydrophobic substrate having a water contact angle of 90° or more, preferably 120° or more, and for example, a superhydrophobic substrate having a water contact angle of 150° or more.

According to the method of the present invention, by using the hydrophobic substrate as the handling substrate, the contact area of water droplets permeated on the surface where the polymer contacts the hydrophobic substrate (contact surface) can be adjusted to be very small. Therefore, the very small pores are formed into the polymer on the contact surface, and the structure having a smooth top surface can be obtained by separating the polymer structure from the hydrophobic substrate after curing and turning over it.

As described above, according to the present invention, the pores having different sizes can be adjustably formed on the surface and inside of the polymer structure using a simple method of utilizing the hydrophobic substrate as the handling substrate when forming the porous polymer structure by spraying steam. Therefore, since there is no need to perform separate processes to form the pores of different sizes on the surface and inside of the polymer structure, and a structured process such as etching is not required to adjust the surface characteristics, it is very advantageous in terms of simplification of the process.

According to the present invention, a material of the handling substrate is not particularly limited as long as it exhibits hydrophobicity and can form a polymer structure on a top portion of the substrate. The handling substrate may include materials such as a glass, a metal and a silicon wafer, and materials formed with hydrophobic treatment may be used.

According to the present invention, a transparent, flexible, or stretchable polymer may be used as the thermosetting polymer to meet the intended use. For example, the thermosetting polymer may include polydimethylsiloxane (PDMS), silicone rubber, polymethylmethacrylate (PMMA), polyurethane (PU), polyester, polyimide (PI), polycarbonate (PC), epoxy resin, etc., and preferably, polydimethylsiloxane (PDMS) or silicone rubber. In addition, an additive or a catalyst may be added for imparting various properties to the thermosetting polymer.

In an embodiment of the present invention, a strengthener such as a silica, a nanocarbon, a metal particle and a metal oxide particle may be added to the thermosetting polymer. For example, the strengthener may include silicon dioxide (silica), a carbon nanotube, a carbon black, an activated carbon, a carbon fiber, a graphite, titanium oxide, lead oxide, tungsten, iron oxide, copper oxide, zinc oxide, alumina, etc. Accordingly, by improving a strength of the polymer structure, it can be applied to the field requiring durability, such as a ship and a railway.

The coating of the thermosetting polymer may include various manners such as a spin coating, a spray coating, a dip coating, a bar coating, a doctor blade coating, and a screen printing.

The thermosetting polymer may be coated to a thickness suitable for a use of the structure, and it is also possible to coat the thermosetting polymer as thin as 4 μm by the method of the present invention. Preferably, the coating thickness may be 50 μm to 10 mm, for example 150 μm to 1 mm. If the thickness is too thin, an ice adhesion of the finally formed porous polymer structure may be relatively high, and if the thickness is too thick, a flexibility of the structure may be reduced.

The method of the present invention may further comprise the step of forming the coated thermosetting polymer in a semi-solid state prior to spraying steam to the coated liquid thermosetting polymer. If the thermosetting polymer is formed in the semi-solid state, since a shape of the polymer is not greatly scattered, it is easy to form the pores by spraying steam into the polymer coating.

The step of forming the semi-solid state may be performed by curing the coated thermosetting polymer at 30 to 50° C. for 1 to 2 hours. The semi-solid state may mean, for example, a state in which the viscosity is 10 to 1,000 Pa-s, preferably 30 to 600 Pa-s.

By spraying steam of high temperature and high pressure to the coated thermosetting polymer, the porous structure can be formed inside the polymer. The steam spraying can be performed by placing a handling substrate coated with the thermosetting polymer to the interior of a pressure vessel capable of generating high temperature and high pressure followed by filling water on a bottom of the vessel, and applying high temperature and high pressure to the vessel to form steam.

In the step of spraying steam, it is preferred to spray the steam of 100 to 150° C. and 70 to 200 kPa, more preferably 100 to 130° C. and 80 to 140 kPa. The spraying time of the steam may vary depending on a thickness of the coated polymer, and may be 1 minute to 1 hour, preferably 20 to 40 minutes. The above temperature, pressure, and spraying time of the steam are described based on polydimethylsiloxane (PDMS), but are not necessarily limited thereto. The temperature and pressure conditions can be changed within a range that does not modify the essential characteristics capable of forming the desired microporous structure according to the boiling temperature that varies depending on a type and performance of a steam generating device or depending on the pressure of the steam.

In the step of spraying steam, a specimen coated with the thermosetting polymer on the handling substrate is preferably positioned at a distance of at least 10 cm, preferably at least 20 cm, from a bottom of the pressure vessel having a heat source. If the position of the polymer is too close to the heat source, the polymer may be cured too quickly, thereby making it difficult to form a deep pore network.

In the step of spraying steam, a heat flux can be controlled to form a pore network over the entire depth of the polymer. For example, by adding a hollow Teflon block below the handling substrate to increase a volume occupied by air of a low heat transfer coefficient and to reduce the heat flux, curing of the polymer can be delayed and the steam can be controlled to penetrate into the polymer deeply.

By such a steam spraying, the steam of high temperature and high pressure penetrates into the liquid polymer deeply and reaches a surface in contact with the handling substrate. In this case, a pore size of the surface where the polymer contacts the handling substrate is determined according to the surface characteristics of the handling substrate.

Specifically, the present invention is characterized in that the contact area between condensed water droplets and the handling substrate is remarkably reduced by using a hydrophobic substrate as the handling substrate. Therefore, relatively very small pores, compared to the interior of the polymer structure, are formed on the surface where the polymer contacts the hydrophobic substrate, whereby the structure having a smooth surface is formed when it is separated from the handling substrate.

According to the present invention, after curing the polymer by spraying steam, a dehydration step may be performed to remove residual water. The dehydration step may be carried out by heating the cured thermosetting polymer in a drying oven.

By separating the porous polymer structure formed according to the above method from the hydrophobic substrate, the porous polymer structure having a smooth surface can be obtained.

Specifically, if the porous polymer structure is separated from the hydrophobic substrate, the smooth surface is formed on the surface where the polymer has contacted the hydrophobic substrate, and the polymer structure having a porous structure below the smooth surface can be obtained. In the polymer structure, the smooth surface may be used as a top surface, and a surface opposite to the smooth surface may be attached to the surface of the object (target surface).

According to the present invention, surface wettability of the porous polymer structure having the smooth surface may be controlled by performing a hydrophilic surface treatment or a hydrophobic surface treatment on the smooth surface.

According to the present invention, if the hydrophilic surface treatment is performed on the smooth surface, it is possible to realize a surface having lower ice adhesion compared to a general hydrophilic surface while modifying the surface to be hydrophilic. That is, the present invention has a feature in that it is possible to realize a surface having excellent wettability and low adhesion by decoupling the wettability from the adhesion.

Alternatively, if the hydrophobic surface treatment is performed on the smooth surface, the effect of low-adhesive property can be maximized to realize ultralow-adhesive property having an ice adhesion of 30 kPa or less.

The methods of the hydrophilic surface treatment and the hydrophobic surface treatment are not particularly limited. For example, the hydrophilic surface treatment may be performed by oxygen plasma treatment, and the hydrophobic surface treatment may be performed by PTFE coating treatment, self-assembled monolayer (SAM) treatment, and the like.

By virtue of the method of spraying steam according to the present invention, the polymer structure having a smooth surface and having a porous structure including a pore network embedded in the polymer structure can be produced.

According to the present invention, the pore sizes formed on the surface and inside of the polymer can be differently adjusted only by using the hydrophobic substrate as the handling substrate without a separate process for adjusting the pore sizes on the surface and inside. In addition, the present invention makes it possible to produce a structure with remarkably low-adhesive property and excellent stain resistance without a chemical modifier or a lubricant. Also, the present invention has a special advantage in that the method for producing the porous polymer structure is very simple, and that the problem of reducing the low-adhesive property due to damage to the microstructure of the surface or loss of the lubricant does not occur.

The porous polymer structure of the present invention comprises a surface portion having a smooth surface; and a porous structure below the surface portion, wherein the porous structure includes a pore network.

Specifically, the smooth porous polymer structure of the present invention may have a smooth surface having an arithmetic average roughness (Ra) of 0.01 to 1 μm, for example, 0.1 to 1 μm, preferably 0.3 to 0.8 μm. In addition, the surface portion may be a porous surface portion that includes the pores having an average particle diameter of 0.1 to 2 μm, for example, 0.5 to 2 μm, preferably 1 to 1.5 μm. Accordingly, the porous polymer structure of the present invention can exhibit low-adhesive property to an ice and a scale.

In the case of a rough surface with high roughness of the surface, an interlocking phenomenon by which the ice is entangled between concave-convex structures occurs so that the ice is easily attached to the rough surface, whereas the smooth surface as in the present invention does not cause the interlocking phenomenon so that the surface has a low adhesion characteristic of the ice and the ice can be easily removed from the surface.

Further, the smooth porous polymer structure of the present invention comprises a porous structure having an average pore size of 10 to 50 μm, preferably 20 to 40 μm below the surface portion, thereby being capable of forming the pores which have a hierarchical pore network. In particular, an inverse hierarchical structure having larger pores as the pores go down from a top surface to a bottom surface may be formed by the structure of the present invention. In addition, a porosity of the porous structure may be 30% or more, preferably 40% to 80%.

Specifically, according to the present invention, stress concentration occurs due to a difference in stiffness between the polymer and the pores in the internal pore network structure, whereby cavities are formed at the interface between the surface and the ice so that the ice adhesion is significantly reduced, which is easy to remove the attached ice. In order to show the effect of reducing the ice adhesion by such cavity formation, it is important that the pore network is embedded just below the surface portion (i.e., a distance between the surface portion and the internal porous structure is very short), for the reason that the porous polymer of the present invention can be formed by contacting the porous structure directly below the surface portion having the smooth surface to maximize the cavity effect.

A distance between the surface portion and the porous structure embedded below the surface portion in the smooth porous polymer structure of the present invention may be 30 μm or less, preferably 10 μm or less, more preferably 3 μm or less, and even more preferably 1 μm or less. The above distance means a distance between the lowermost surface of the pores present in the surface portion and the uppermost pores present in the porous structure. As the distance between the surface and the porous structure is narrowed, the stress concentration effect due to the difference in stiffness between the polymer and the pores can be transferred to the surface, and as a result, the cavities can be formed at the interface between the surface and the ice, which significantly reduces the ice adhesion.

The smooth porous polymer structure of the present invention can exhibit excellent low-adhesive property and stain resistance due to combination of such a surface characteristic and the internal structure. It was confirmed by the Experimental Examples of the present invention to be described later that the smooth porous polymer structure of the present invention can implement an ice adhesion of 50 kPa or less, preferably 30 kPa. In addition, it was confirmed that a critical flow rate for a scale can be 4 L/min or less, preferably 3.5 L/min or less, and that a removal rate of the scale can be achieved to 80% or more, preferably 90% or more.

Accordingly, the smooth porous polymer structure of the present invention is attached to ice-freezing portions in all industries that require voluntary defrosting due to performance degradation and accidents caused by the ice, such as an aircraft, an automobile, a ship, a building, and a LNG air-type vaporizer, so that the porous polymer structure can exhibit a low-adhesive property and can be applied to various industrial fields requiring the stain resistance.

For example, the smooth porous polymer structure of the present invention can be usefully applied to a ship or aircraft field where the ice formed on the surface should be easily removed, or a river field where the foreign substances such as a scale should be easily removed. In addition, the porous polymer structure can be usefully applied to the fields of the medical treatment and household appliance where hygiene is important due to sensitiveness to contamination of the surface. As an example, the smooth porous polymer structure of the present invention can be applied to an inner wall of a medical tube to minimize accumulation of the stains, and can be applied to a medical device and sensor to simultaneously implement flexibility and stain resistance required for signal detection of a human body.

In an exemplary embodiment of the present invention, the smooth porous polymer structure of the present invention can be used as a protective film, for example, a film for protecting the surface of a transportation means. In this case, the transportation means may include vessels such as a submarine, a yacht, an oil tanker, a cruise ship, a fishing boat, an icebreaker, ferry, and a freshwater ship/boat; automobiles such as a passenger car, a truck, and a dump truck; and aircrafts such as a passenger plane and a fighter jet.

Since the smooth porous polymer structure of the present invention does not contain a microstructure or a lubricant on its surface, there are no problems in that low-adhesive property and stain resistance is reduced due to damage to the microstructure or loss of the lubricant. In addition, the smooth porous polymer structure of the present invention can be formed thinly so that it can be attached like a sticker and can be applied to a curved surface by virtue of its flexibility, thereby being capable of applying in various industrial fields without any limitation.

### Example

The present invention will be described in more detail through the following Examples. However, since these Examples show some experimental methods and compositions to illustratively explain the present invention, the scope of the present invention is not limited to these Examples.

### Preparation Example: Production of a Porous Polymer Structure Having a Smooth Surface

A liquid thermosetting polymer was coated on a hydrophobic substrate and steam was sprayed thereon to produce a porous polymer structure having a smooth surface.

A liquid silicone elastomer base and a curing agent (Sylgard 184, Dow Corning) were mixed at a weight ratio of 10:1 using a centrifugal mixer (ARE-310, Thinky). Next, the silicone elastomer was spin-coated on a hydrophobic handling substrate having a water contact angle of 150° at 300 rpm for 5 minutes, and then positioned in an autoclave of about 120° C. and 90 kPa and exposed to steam of high temperature/high pressure for 30 minutes. At this time, a distance between the bottom of a container with a heat source and a specimen was maintained at 20 cm or more, and a hollow Teflon block was added to delay curing so that the porous structure was formed throughout the entire depth of the polymer.

By this process, during curing of the silicone elastomer, the steam of high temperature was penetrated into the silicone elastomer to form a porous polymer structure having a hierarchically connected pore structure embedded throughout the entire depth of the silicone elastomer.

Next, the porous polymer structure was dehydrated in an oven at 100° C. for 30 minutes to remove residual water, and separated from the hydrophobic substrate, thereby forming a smooth porous polymer structure having a thickness of 200 μm.

In order to transcribe the smooth porous polymer structure into a target surface, an adhesive layer having a thickness of 5 μm was formed on the target surface. In this case, a mixture of silicone elastomer and hexane at a weight ratio of 10:1 was used as the adhesive. After the adhesive layer was partially cured on a hot plate at 60° C. for 10 minutes, the smooth porous polymer structure was attached to the target surface and completely cured at 100° C. for hour.

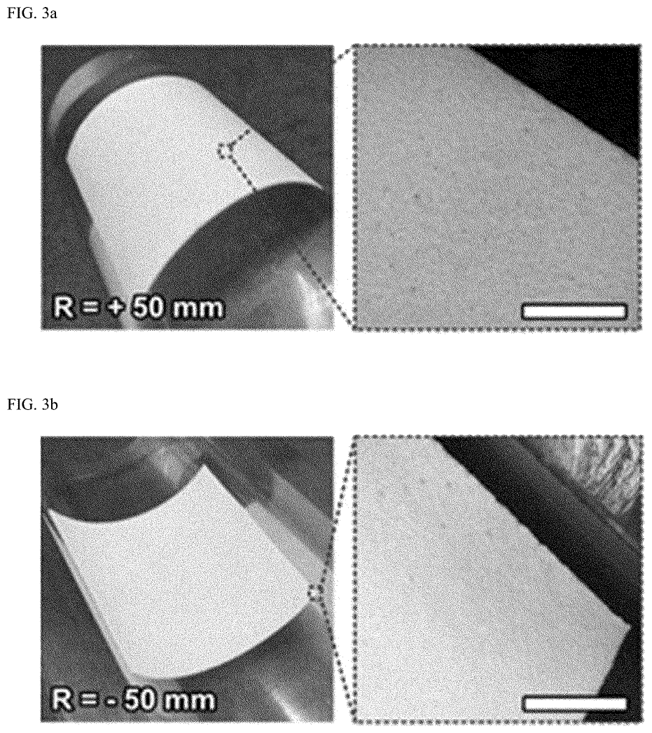

FIG. 2 shows a photograph (left), an optical microscope image (center), and an SEM image (right) of the produced smooth porous structure. Referring to FIG. 2, it can be confirmed that the produced structure has a smooth surface, and further confirmed from the SEM image that a pore network hierarchically connected below the smooth surface is formed by water penetration of droplets.

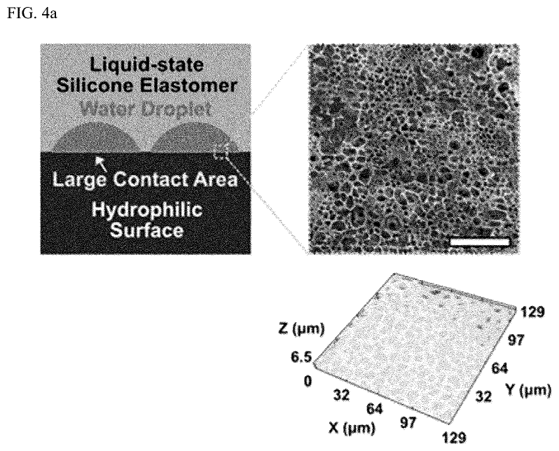

FIG. 3 shows a photograph (left) and an optical microscope image (right) having the smooth porous polymer structure of Preparation Example attached to a convex surface (FIG. 3a) and a concave surface (FIG. 3b). Referring to the above image, it is confirmed that the porous polymer structure of the present invention exhibits high flexibility and can be stably attached to a curved surface.

### Experimental Example 1: Comparison of a Surface Morphology of the Polymer Structures

For the smooth porous polymer structure of Preparation Example, a surface morphology and a surface roughness were measured using a scanning electron microscope (SEM, Hitachi, S-4800) and a confocal laser scanning microscope (CLSM, Olympus, OLS4100). A porous polymer structure produced in accordance with the method of Preparation Example using a hydrophilic substrate having a water contact angle of 7° as a handling substrate was compared with the structure of Preparation Example in their surface characteristics.

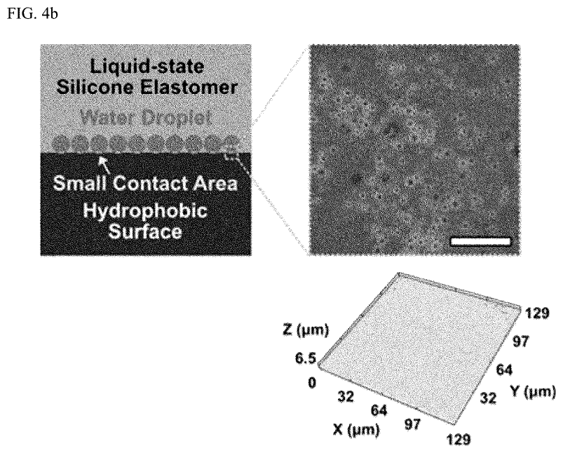

FIG. 4 shows a difference in the surface characteristics varying with wettability of the handling substrate in the method of producing the porous polymer structure. From the SEM image and the confocal laser scanning microscope image of FIG. 4, it can be seen that a difference in the pore size and roughness of the surface varies depending on a difference in the contact area of the water droplets.

Specifically, in case the hydrophilic substrate is used as the handling substrate as shown in FIG. 4a, it can be confirmed that large water droplets are formed by the wettability of the permeated steam on the surface in contact with the handling substrate, and as a result, a rough surface with large pores is formed on the surface of the polymer.

On the other hand, in case a hydrophobic substrate is used as the handling substrate as shown in FIG. 4b, the permeated steam remains as small droplets while maintaining a round shape on the surface in contact with the handling substrate, thereby forming a smooth surface with very small pores on the surface of the polymer.

### Experimental Example 2: Comparison of an Arithmetic Average Roughness and a Pore Size Distribution on the Surface of the Polymer Structures

For each structure of Experimental Example 1, an arithmetic average roughness (Ra) and a pore size distribution according to depth were measured and compared.

The arithmetic average roughness was measured at 432× magnification for 10 different cut surfaces in each structure, and 3 samples per a structure were used.

As a result of measuring the arithmetic average roughness, it was confirmed that the structure produced using the hydrophilic handling substrate showed rough surface characteristics with an arithmetic average roughness of 2.64±0.62 μm in the surface, whereas the structure produced using the hydrophobic handling substrate according to the Preparation Example of the present invention had an arithmetic average roughness of 0.48±0.04 μm in the surface, which shows a smooth surface characteristic slightly higher than the arithmetic average roughness (0.11±0.04 μm) of a general silicone elastomer.

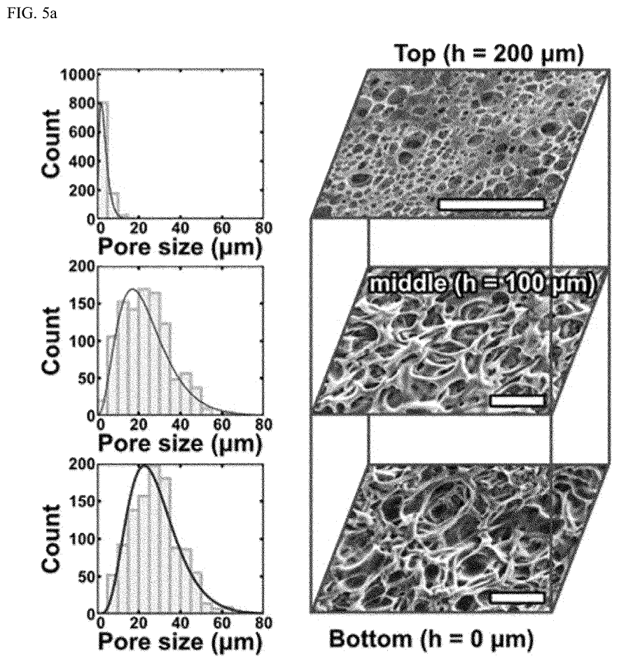

FIGS. 5a and 5b show pore size distribution varying with a depth for the structures of FIGS. 4a and 4b, respectively. A pore size of the sample was measured using an image analysis program (STREAM, Olympus), and three samples per a structure were used. The pore size was measured and calculated at 5 different positions in each sample.

Referring to the measurement result of the pore size, it could be confirmed that large pores having an average particle diameter of 3.44±2.39 μm are formed on the surface portion of the structure in case the hydrophilic handling substrate is used, whereas the structure produced using the hydrophobic handling substrate according to the present invention has small pores of 1.33±0.89 μm in the surface portion. On the other hand, it can be confirmed that the pore sizes of the internal porous structures are similar with each other.

Accordingly, it was confirmed that the pore size of the polymer surface portion and the roughness of the top surface can be adjusted according to the wettability of the handling substrate.

### Experimental Example 3: Comparison of an Ice Adhesion Between the Polymer Structures

An ice adhesion for the smooth porous PDMS structure (Porous PDMS, Smooth) of Preparation Example was measured using a shear force. In addition, the ice adhesion was also measured under the same conditions for a general PDMS having a smooth surface (bare PDMS, Smooth) and a porous PDMS having a rough surface (Porous PDMS, Rough). The measured results were compared with each other.

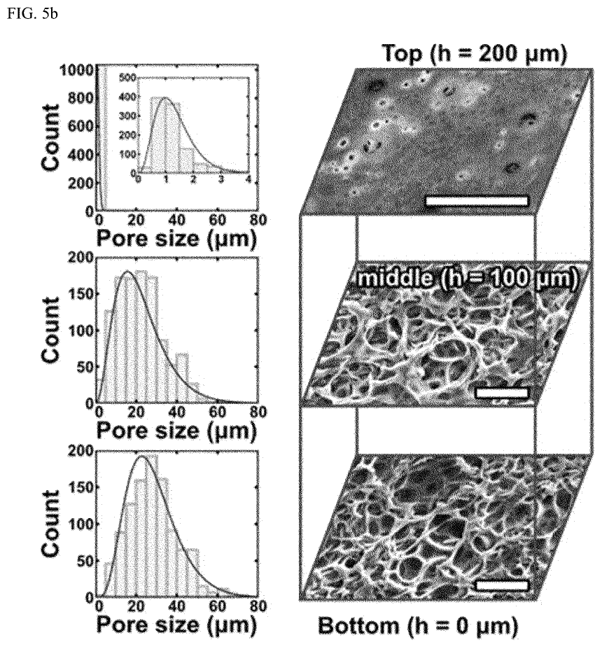

Each construct sample was fixed on a stage at a temperature of −15° C., and a plastic tube with a diameter of 0.75 cm and a height of 1 cm filled with 200 μl of deionized water was positioned on the surface of the sample. When the deionized water is completely frozen, an external force was applied to move a force probe positioned at a distance of 0.5 mm from the sample by 0.05 mm s⁻¹. The external force required to remove an ice from the surface of the sample was measured using a load cell with a sensitivity of 5 mN. Five samples per each structure were used to perform a test at five different positions for each sample, and the results of measuring the ice adhesion were shown in FIG. 6.

The smooth porous PDMS of the present invention had an ice adhesion of 25.73 kPa, which is the low adhesion corresponding to 14% of a general PDMS having a smooth surface. From this, it could be confirmed that the pore network inside the structure had a very large effect on the ice adhesion. It was confirmed in the porous structure that a stress concentration occurs due to a difference in stiffness between the pores and the polymer, and thus, the ice adhesion is reduced by forming a cavity at the interface between the surface and the ice.

Further, the smooth porous PDMS of the present invention had the ice adhesion much lower compared to that of the porous PDMS having a rough surface. This is because an interlocking phenomenon by which the ice is entangled between the concavo-convex structures occurs on the rough surface, whereas such a phenomenon does not occur on the smooth surface.

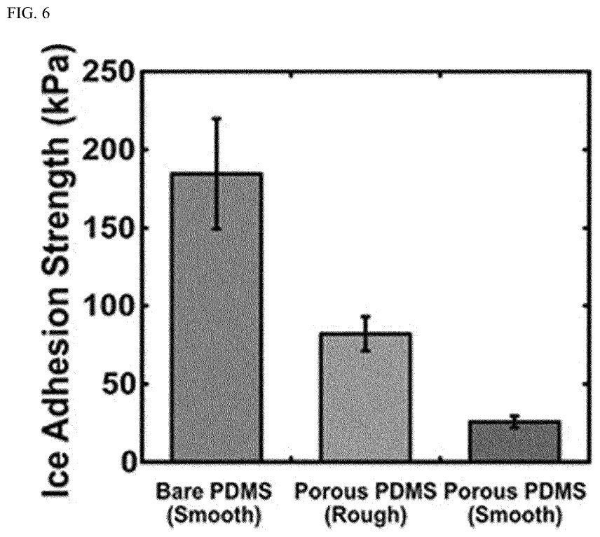

FIG. 7 shows an ice adhesion force-position profile of each structure. A relationship between the ice adhesion and the stress concentration effect of the pore network can be confirmed from FIG. 7. When an ice column attached to the surface is removed, a load reaches a peak, and after that, the load decreases rapidly because the ice is separated from the surface. In the case of the general PDMS and porous PDMS with a smooth surfaces, it could be confirmed that the applied load rapidly decreased vertically after the ice column was separated.

It could be confirmed from the test results of the ice adhesion that in order to implement the low-adhesive property, the porous structure must be embedded below the surface and have a smooth top surface.

### Experimental Example 4: Comparison of an Ice Adhesion after Surface Treatment of the Polymer Structures

An ice adhesion was measured with the method of Experimental Example 3 after the surface of each structure was converted to superhydrophilicity or superhydrophobicity.

In the experiment, a water contact angle was converted to less than 10° using plasma treatment (300 W, 13.56 MHz, 1 min) for the superhydrophilic treatment. Also, in the case of the superhydrophobic treatment, the surface of each structure was spin coated using a Teflon solution (1 wt % AF2400, FC-40) mixed with polytetrafluoroethylene (PTFE) nanoparticles (200-300 nm, Microdisperse-200, Polysciences, Inc) at 2,000 rpm for 1 minute, and was cured at 165° C. for 10 minutes and 245° C. for 5 minutes to give a surface treatment of 150° or more and a sliding angle of less than 5°.

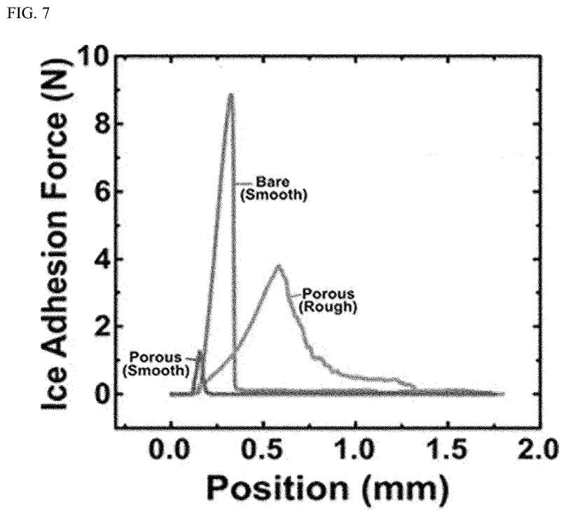

FIG. 8 is a graph showing the results of measuring an ice adhesion after converting the surface of each structure to superhydrophilicity or superhydrophobicity. It could be confirmed from FIG. 8 that upon the superhydrophilic surface treatment, the ice adhesion is increased compared to the conventional specimen, but is still the lowest in the case of the smooth porous PDMS. In addition, it can be confirmed that the hydrophilicity is exhibited from a static water contact angle of water droplets in the graph.

On the other hand, it was confirmed that the low adhesion of the structure was further improved upon the superhydrophobic surface treatment, and so was reduced to a very low level (19.2 kPa).

According to the above experimental results, it could be confirmed that the present invention provides the porous polymer structure which can reduce the ice adhesion while maintaining the hydrophilicity, by decoupling the control of the ice adhesion and surface wettability. That is, when the structure of the present invention is subjected to the hydrophilic surface treatment, it is possible to maintain the hydrophilicity while reducing the ice adhesion, and when the structure of the present invention is subjected to the superhydrophobic surface treatment, it is possible to maximize the low-adhesive property.

### Experimental Example 5: Comparison of an Anti-Scale Performance of the Polymer Structures

An anti-scale performance for the smooth porous polymer structure of Preparation Example (Porous PDMS, Smooth), a general PDMS having a smooth surface (bare PDMS, Smooth) and a porous PDMS having a rough surface (Porous PDMS, Rough) was measured under the same conditions and the measurement results were compared. In this case, in order to observe formation of a white scale clearly, a blue structure was produced by adding a dye upon formation of the structure.

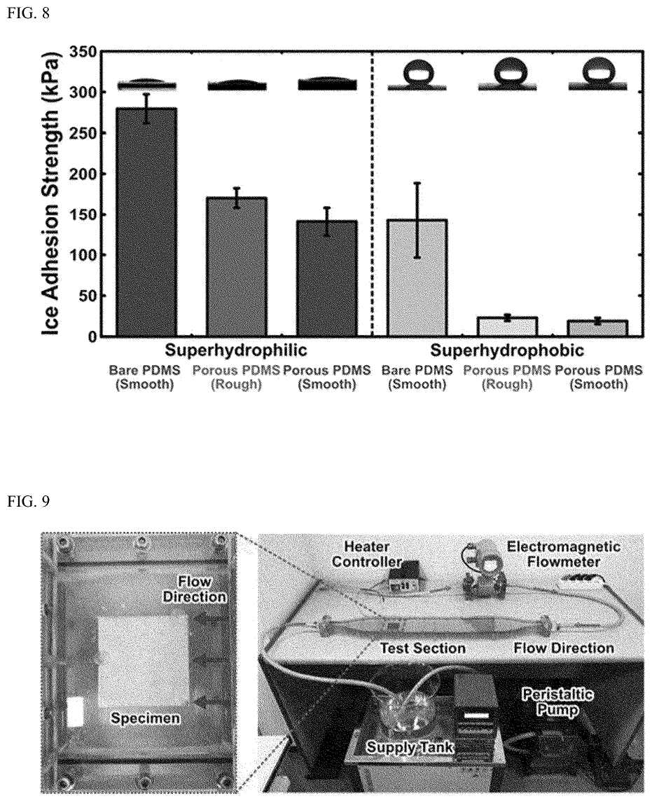

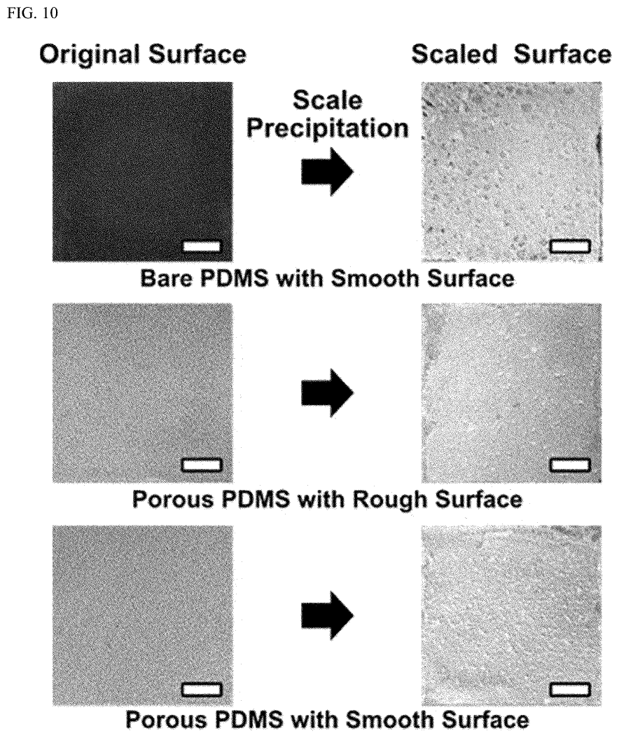

As shown in FIG. 9, each of the structure samples was positioned in a test section of a flow circulation device, and a supersaturated scale solution of 40° C. was circulated for 3 hours at a flow rate of 4 L/min. 0.04M calcium nitrate tetrahydrate (Ca(NO₃)₂·4H₂O, Sigma-Aldrich) and 0.04M sodium sulfate (Na₂SO₄, Sigma-Aldrich) were used as the supersaturated scale solution. Upon the experiment, the scale formation on the surface of the sample was accelerated by heating the sample under operation of a planar heater having a surface temperature of 130° C. After the scale was formed, the sample was completely dried in air, and photographs before and after the scale accumulation were compared and shown in FIG. 10.

Referring to the photographs before (left) and after (right) the scale accumulation in FIG. 10, it was confirmed that the white scale was formed in all the samples, but the structure according to the present invention exhibited a bluish color due to a small amount of the scale.

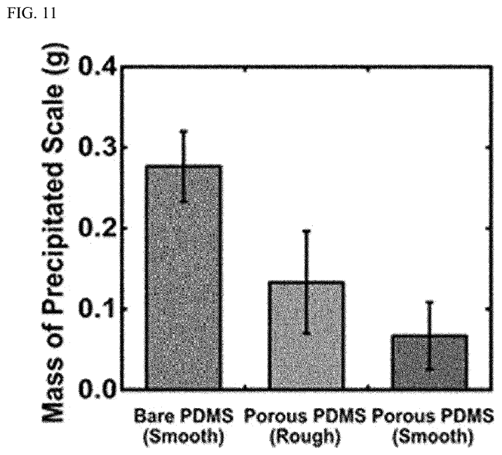

Further, a weight of the sample before and after the test was measured using a high-precision balance having a resolution of 0.01 mg, and an amount of the scale accumulated by a difference in the weight before and after the test was measured. The experiment was performed using 5 samples per each structure, and the scale weight accumulated in an area of 25 cm² was measured, and the results were shown in FIG. 11.

As a result of the experiment, it was confirmed that the most scale was accumulated in the general PDMS structure having a smooth surface without a porous structure, and that the scale weight in the smooth porous PDMS was 76% lighter. An amount of the scale accumulated in the porous PDMS having a rough surface was smaller than that accumulated in the general PDMS, but was more than that accumulated in the smooth porous PDMS.

Accordingly, it could be confirmed that the structure of the present invention has a low adhesion to the scale on the surface and is easy to separate, and that the anti-scale performance is maximized only when the smooth surface and the porous structure coexist.

### Experimental Example 6: Comparison of a Scale Removal Performance of the Polymer Structures

A scale removal performance for the smooth porous polymer structure of Preparation Example (Porous PDMS, Smooth), a general PDMS having a smooth surface (bare PDMS, Smooth) and a porous PDMS having a rough surface (Porous PDMS, Rough) was measured under the same conditions and the measurement results were compared.

In order to form an equal amount of the scale on each sample surface, all specimens were placed in a beaker filled with saturated calcium sulfate ½hydrate (CaSO₄.½H₂O, Sigma-Aldrich) at 25° C., and then the beaker was heated under the static condition at 50° C. for 24 hours. After formation of the scale, the samples were placed in a flow circulation device and slowly filled with water, and then a flow rate was gradually increased to measure a critical water flow rate and the scale was removed from the surface.

A removal rate (%) in the scale removal process was calculated as [(a weight of scale−a weight of residual scale)/a weight of scale]×100(%). In this case, the weight of the scale was calculated as a difference in a weight of the sample before and after the scale formation, and the weight of the residual scale was calculated as a difference between a weight of the sample after the scale removal and a weight of the sample before the scale formation.

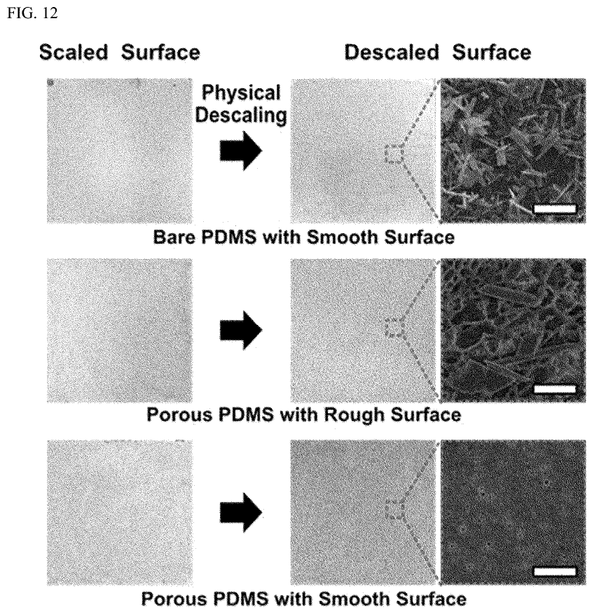

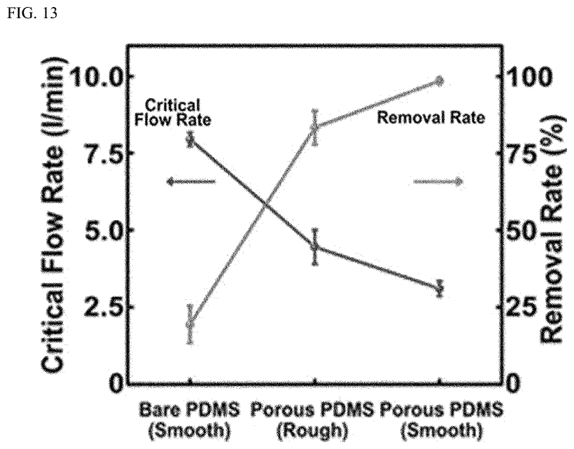

FIG. 12 shows photographs before and after the scale removal process, and indicates a comparison between a scale-contaminated surface (left) and a washed surface (right). FIG. 13 shows a graph of the results of performing the test on five different samples per each structure and calculating a critical flow rate, which means a minimum flow rate under the condition that the accumulated scale is eliminated, and a removal rate at each critical flow rate.

Referring to the above results, it can be confirmed that the smooth porous PDMS according to the present invention clearly shows a color change before and after the scale removal at a critical flow rate of 3.1 L/min. In addition, it can be confirmed that the surface of the smooth porous PDMS is not damaged and that the scale is cleanly decoupled (98.5%).

Contrary to the above, it could be confirmed that the general smooth PDMS shows no clear difference in a color even at a maximum flow rate of 8.0 L/min, which means that there is almost no decoupling from the accumulated scale (<19%).

Further, it could be confirmed that the rough porous PDMS has a rather high critical flow rate of 4.5 L/min and a rather low removal rate of 83.3%, and that a residual of the scale remains in the pores of the rough surface.

Therefore, it can be seen that the structure of the present invention has an excellent stain resistance in view that the structure indicates a low scale adhesion as well as excellent scale removal performance.

As explained above, since specific parts of the content of the present invention have been described in detail, any person who has an ordinary knowledge in the relevant art will obviously understand that those specific descriptions are merely preferred embodiments without limiting the scope of the present invention by the descriptions. Accordingly, the substantial scope of the present invention will be defined by the appended claims and their equivalents.

1. A method for producing a porous polymer structure having a smooth surface, comprising the steps of:
coating a thermosetting polymer on a hydrophobic substrate;
forming a porous polymer structure by curing the coated thermosetting polymer while spraying steam to it; and
obtaining the porous polymer structure having a smooth surface by separating the porous polymer structure from the hydrophobic substrate.

2. The method for producing the porous polymer structure having the smooth surface according to claim 1,
wherein a water contact angle of the hydrophobic substrate is 90° or more.

3. The method for producing the porous polymer structure having the smooth surface according to claim 1,
wherein the thermosetting polymer comprises one or more selected from the group consisting of polydimethylsiloxane (PDMS), silicone rubber, polymethylmethacrylate (PMMA), polyurethane (PU), polyester, polyimide (PI), polycarbonate (PC), and epoxy resin.

4. The method for producing the porous polymer structure having the smooth surface according to claim 1,
wherein at least one strengthener selected from the group consisting of silica, nanocarbon, metal particles and metal oxide particles is added to the thermosetting polymer.

5. The method for producing the porous polymer structure having the smooth surface according to claim 1,
wherein the step of spraying steam is performed by spraying steam of 100 to 150° C. and 70 to kPa to the coated thermosetting polymer.

6. The method for producing the porous polymer structure having the smooth surface according to claim 1,
further comprising the step of drying the thermosetting polymer after curing it.

7. The method for producing the porous polymer structure having the smooth surface according to claim 1,
wherein the porous polymer structure has a thickness of 50 μm to 10 mm.

8. The method for producing the porous polymer structure having the smooth surface according to claim 1,
further comprising the step of carrying out a hydrophilic surface treatment or a hydrophobic surface treatment on the smooth surface.

9. A porous polymer structure comprising:
a surface portion having a smooth surface; and
a porous structure below the surface portion.

10. The porous polymer structure according to claim 9,
wherein an arithmetic average roughness (Ra) of the smooth surface is 0.01 to 1 μm.

11. The porous polymer structure according to claim 9,
wherein the surface portion has pores having an average particle diameter of 0.1 to 2 μm.

12. The porous polymer structure according to claim 9,
wherein an average particle diameter of pores in the porous structure is 10 to 50 μm.

13. The porous polymer structure according to claim 9,
wherein a distance between the surface portion and the porous structure is 30 μm or less.

14. The porous polymer structure according to claim 9,
wherein the smooth surface is subjected to a hydrophilic surface treatment or a hydrophobic surface treatment.

15. A film for protecting a surface of a transportation means, comprising the porous polymer structure according to claim 9.
